(19) United States
(12) Patent Application Publication
(10) Pub. No.: US 2025/0189947 A1
(43) Pub. Date: Jun. 12, 2025

(54) CONTROL DEVICE

(71) Applicant: Fanuc Corporation, Minamitsuru-gun, Yamanashi (JP)

(72) Inventors: Ryuutarou NISHIMURA, Minamitsuru-gun, Yamanashi (JP); Takeshi MOCHIDA, Minamitsuru-gun, Yamanashi (JP)

(73) Assignee: Fanuc Corporation, Minamitsuru-gun, Yamanashi (JP)

(21) Appl. No.: 18/842,484

(22) PCT Filed: Mar. 15, 2022
(86) PCT No.: PCT/JP2022/011593

§ 371 Date: Aug. 29, 2024

(51) Int. Cl. G05B 19/19

(52) U.S. Cl. CPC G05B 19/19; G05B 2219/49012

(57) ABSTRACT

A control device controls, on the basis of a processing program, a machine having at least two shafts. The control device includes: a ratio calculation unit that calculates a ratio related to the operation of the shafts; and a set value calculation unit that dynamically calculates a set value for the machine, from the ratio calculated by the ratio calculation unit and a prescribed parameter related to the shafts. The set value of the machine is changed according to the ratio related to the operation of the shafts.

### CROSS REFERENCE TO RELATED APPLICATIONS

This is the U.S. National Phase application of PCT/JP2022/011593, filed Mar. 15, 2022, the disclosure of this application being incorporated herein by reference in its entirety for all purposes.

### FIELD OF THE INVENTION

The present invention relates to a control device.

### BACKGROUND OF THE INVENTION

When using a control device to control an industrial machine for machining a workpiece, it may be necessary to perform the control while considering the response of each operating part. For example, in a laser machine, the response to a command from the control device differs between the laser output of a laser oscillator and operations of driving units for moving a table and a machining head. In a laser machine, the response of laser output from the laser oscillator (the time from the point at which the laser output command is issued to the point at which a laser is actually output) is considerably faster than the response of the operations of the driving units for moving the table and the machining head (the time from the point at which the movement command is issued to the point at which the table or the machining head actually starts to move). In order to absorb the differences in the responses of the respective units in a laser machine, a delay time is set on the output command issued to the laser oscillator so as to align the output command with the timing of the movement operations of the table and the machining head (for example, PTL 1 or the like). Furthermore, in a water jet machine, the response of a water flow output from a cutting head is slower than the response of the operations of the driving units for moving the table and the machining head. Therefore, in order to absorb the differences in the responses of the respective units of a water jet machine, setting is performed so that the command to output the water flow is issued earlier than the movement commands of the table and the machining head are output.

### PATENT LITERATURE

[PTL 1] Japanese Patent No. 3405797

### SUMMARY OF THE INVENTION

When the response differs among the plurality of driving parts for moving the table and the machining head, it is difficult to optimize the operation timings of other operating parts. For example, in a laser machine, the relative positions of the machining head and the workpiece are controlled by driving at least two axes (an X axis and a Y axis, for example) in order to move the table and the machining head. In this case, if the response on the X axis and the response on the Y axis are different, how to optimize the timings at which output commands are issued to the laser oscillator in relation to the respective axes becomes a problem. The influence of this response difference on the processing result is particularly large during high-speed machining.

There is therefore a need for more appropriate control taking into consideration the response of each operating part of the industrial machine.

One aspect of the present disclosure is a control device for controlling a machine having at least two axes on the basis of a machining program, the control device including: a ratio calculator for calculating a ratio related to operations of the axes; and a setting value calculator for dynamically calculating a setting value of the machine from the ratio calculated by the ratio calculator and a predetermined parameter relating to the axes, wherein the setting value of the machine is modified in accordance with the ratio of the operations of the axes.

According to an aspect of the present disclosure, it can be expected that more appropriate control, taking into consideration the response of each operating part, will be performed even when the response differs among a plurality of driving units.

### BRIEF DESCRIPTION OF DRAWINGS

FIG. 1 is a schematic hardware configuration diagram of a control device according to an embodiment of the present invention.

FIG. 2 is a block diagram showing schematic functions of a control device according to an embodiment of the present invention.

FIG. 3 is a view illustrating a method for calculating a ratio related to operations of respective operating parts using a command ratio calculator.

FIG. 4 is a view showing examples of parameters relating to the respective operating parts, which are stored in an operating parameter storage.

FIG. 5 is a view showing examples of a relationship between a predetermined setting value and the parameters relating to the respective operating parts, which are stored in a relationship storage.

FIG. 6 is a view illustrating an example of calculation of the setting value by a setting value calculator.

FIG. 7 illustrates machining positions 311 to 314 of slits formed in a workpiece 300.

FIG. 8 is a view showing an example in which slits are machined using a control device according to the prior art.

FIG. 9 is a view showing an example in which slits are machined using the control device according to an embodiment of the present invention.

### DETAILED DESCRIPTION OF EMBODIMENTS OF THE INVENTION

Hereinafter, an embodiment of the present invention will be described together with the Figures.

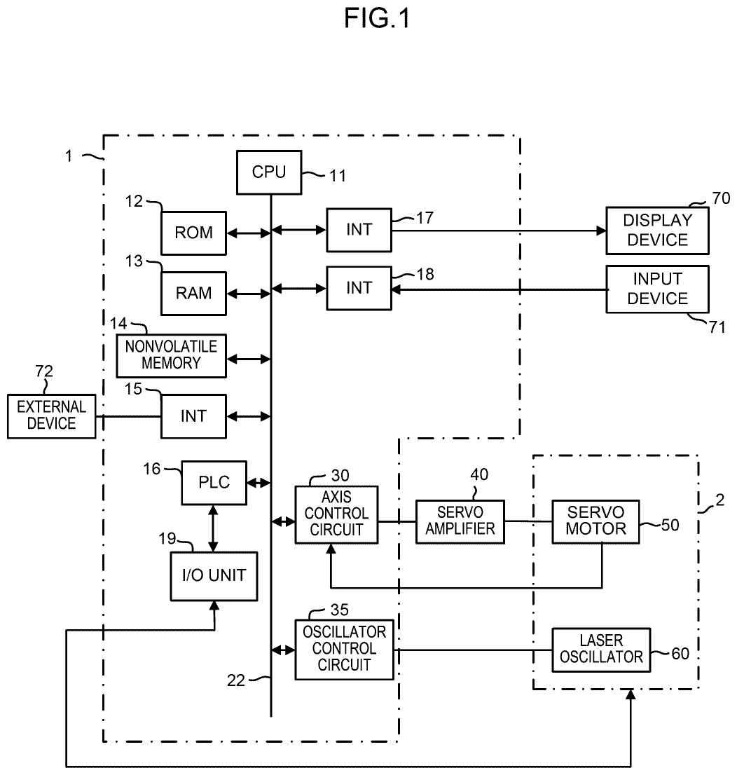

FIG. 1 is a schematic hardware configuration diagram showing main parts of a control device according to an embodiment of the present invention. A control device 1 according to this embodiment can be actualized as a control device for controlling an industrial machine 2 disposed in a manufacturing site such as a factory. The industrial machine 2 has at least two axes. Furthermore, the industrial machine 2 includes operating parts that differ from the two axes. Hereinafter, a control device 1 for controlling a laser machine as the industrial machine 2 will be described on the basis of examples.

In the present invention, a CPU 11 included in the control device 1 is a processor for performing overall control of the control device 1. The CPU 11 reads a system program stored in a ROM 12 via a bus 22, and controls the entire control device 1 in accordance with the system program. A RAM 13 temporarily stores temporary calculation data, display data, various kinds of data input from the outside, and so on.

A nonvolatile memory 14 is constituted by, for example, a memory, an SSD (Solid State Drive), or the like backed up by a battery, not shown in the Figures, and a storage state of the nonvolatile memory 14 is retained even when a power supply of the control device 1 is switched off. The nonvolatile memory 14 stores data acquired from the industrial machine 2, a control program and data that are read from an external device 72 via an interface 15, a control program and data that are input through an input device 71, a control program and data that are acquired from another device via a network 5, and so on. The control programs and data that are stored in the nonvolatile memory 14 may be expanded in the RAM 13 when being executed/used. Furthermore, various system programs such as a known analysis program are written in advance to the ROM 12.

The interface 15 is an interface for connecting the CPU 11 in the control device 1 to the external device 72, which is a USB device or the like. Control programs, setting data, and so on used to control the industrial machine 2, for example, are read from the external device 72 side. Further, control programs, setting data, and so on edited in the control device 1 can be stored in an external storage means through the external device 72. A PLC (programmable logic controller) 16 executes a ladder program so as to output signals to and control equipment (for example, a plurality of sensors such as a temperature sensor and a humidity sensor, actuators such as a robot disposed on the periphery, and so on) attached to the industrial machine 2 via an I/O unit 19. Furthermore, the interface 15 receives signals from various switches of an operating panel mounted on the body of the industrial machine 2, peripheral devices, and so on, and after performing required signal processing, transmits the signals to the CPU 11. Note that depending on the configuration of the industrial machine 2, a laser oscillator 60 can also be controlled by the PLC 16.

For example, various data read to the memory, data obtained as a result of executing a program or the like are output to and displayed on a display device 70 via an interface 17. In addition, the input device 71, which is constituted by a keyboard, a pointing device, or the like, transmits commands, data, and so on based on operations performed by an operator via an interface 18 to the CPU 11.

An axis control circuit 30 for controlling the axes of the industrial machine 2 receives a command for moving an axis by a predetermined movement amount from the CPU 11, and outputs the axis command to a servo amplifier 40. The servo amplifier 40 receives the command and drives a servo motor 50 for moving the axis provided in the industrial machine 2. The servo motor 50 of the axis has an inbuilt position/speed detector, and performs feedback control of the position and speed by feeding back a position/speed feedback signal from the position/speed detector to the axis control circuit 30. Note that on the hardware configuration diagram of FIG. 1, only one axis control circuit 30, one servo amplifier 40, and one servo motor 50 are shown, but in actuality, these components are provided in a number corresponding to the number of axes of the industrial machine 2 serving as the control target. For example, a laser machine has three linear axes, namely an X axis, a Y axis, and a Z axis, along which the laser oscillator 60 and the workpiece move relative to each other.

An oscillator control circuit 35 for controlling the laser oscillator 60 provided in the industrial machine 2 receives a laser output control command from the CPU 11, and outputs the received command to the laser oscillator 60. Note that on the hardware configuration diagram of FIG. 1, only one oscillator control circuit 35 and one laser oscillator 60 are shown, but in actuality, these components are provided in a number corresponding to the number thereof provided in the industrial machine 2 serving as the control target.

The control device 1 having the configuration described above moves a machining head, not shown in the Figures, and a table, not shown in the Figures, on which the workpiece is disposed relative to each other by outputting movement commands to the servo motors 50 for driving the respective axes. Then, when the machining head is moved to a machining position of the workpiece, the control device 1 outputs a laser from the machining head by transmitting an output command signal to the laser oscillator 60. The workpiece is then machined by the output laser. From the point at which the command is output to each of the axes to the point at which the servo motor 50 is actually driven so that the machining head or the table moves, a delay caused by the servo mechanism or a mechanical movement delay occurs. Also, from the point at which the output command signal is transmitted to the laser oscillator 60 to the point at which the laser is actually output, a delay caused by the laser oscillation mechanism or a signal transmission delay occurs. These delay times differ between the axes and also according to the laser oscillator 60.

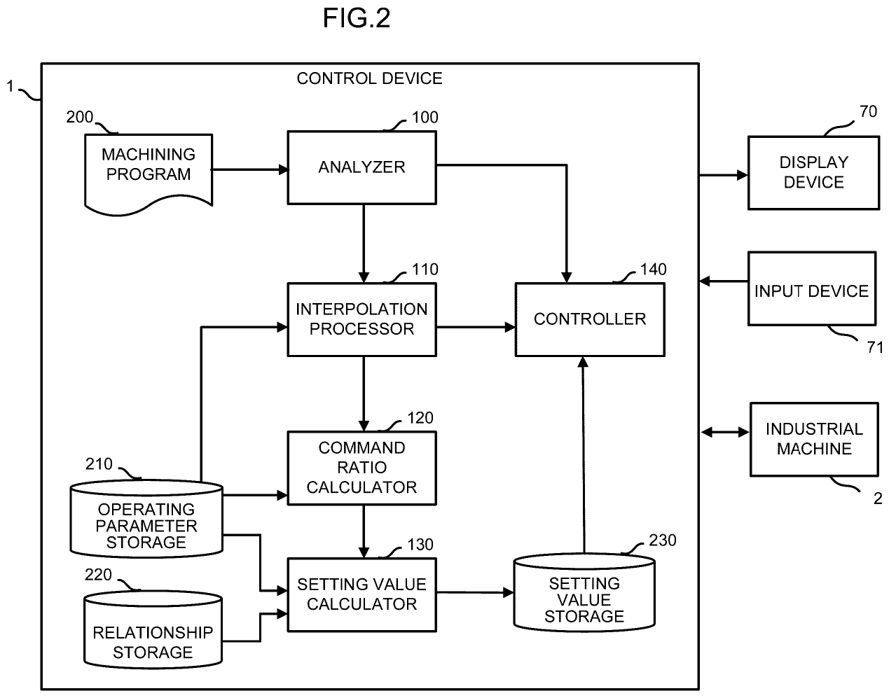

FIG. 2 shows functions included in the control device 1 according to this embodiment of the present invention as a schematic block diagram. The respective functions included in the control device 1 according to this embodiment are realized by having the CPU 11 provided in the control device 1 shown in FIG. 1 execute the system program in order to control the operations of the respective parts of the control device 1.

The control device 1 according to this embodiment includes an analyzer 100, an interpolation processor 110, a command ratio calculator 120, a setting value calculator 130, and a controller 140. Further, a machining program 200 for controlling the operation of the industrial machine 2 is stored in advance in the RAM 13 or the nonvolatile memory 14 in the control device 1. Furthermore, an operating parameter storage 210, which is an area for storing parameters relating to the operating parts of the industrial machine 2, a relationship storage 220, which is an area for storing a relationship between the respective operating parts of the industrial machine 2 and a predetermined setting value, and a setting value storage 230, which is an area for storing a predetermined setting value relating to control of the industrial machine 2, are prepared in advance in the RAM 13 or the nonvolatile memory 14 in the control device 1.

The analyzer 100 reads each block of the machining program 200 and analyzes commands included in the read block. Each block of the machining program 200 includes movement commands for moving the servo motors 50 for driving the respective axes of the industrial machine 2, commands for switching laser output by the laser oscillator 60 in the industrial machine 2 ON/OFF, and so on. The analyzer 100 creates movement command data for the servo motor 50 based on the movement command, for example. The analyzer 100 also generates data for controlling output signals output to the laser oscillator 60 on the basis of the commands for switching laser output by the laser oscillator 60 ON/OFF.

The interpolation processor 110 generates interpolation data by calculating, on the basis of the movement command data created by the analyzer 100, a movement destination of each interpolation period (control period) on a command path. The interpolation data are created for each of the servo motors 50 that drive the respective axes of the industrial machine 2. The interpolation data created by the interpolation processor 110 are output to the controller 140.

The command ratio calculator 120 calculates ratios related to operations of the respective operating parts provided in the industrial machine 2 on the basis of the interpolation data generated by the interpolation processor 110. The command ratio calculator 120 acquires a movement amount, per control period, of each axis from the interpolation data. Then, on the basis of the acquired movement amount of each axis, the command ratio calculator 120 calculates a ratio of a movement speed of each axis to a movement speed along the command path as the ratios related to the operations of the respective operating parts.

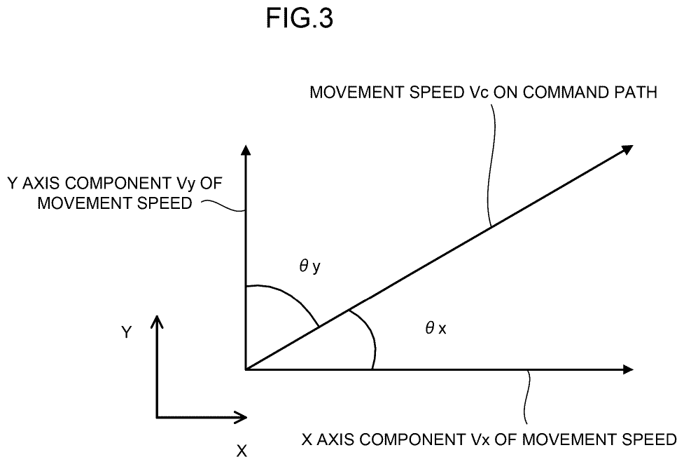

FIG. 3 is a view illustrating a method for calculating the ratios related to the operations of the respective operating parts using the command ratio calculator 120. FIG. 3 shows an example of a command path that moves on an XY plane. In this case, the command ratio calculator 120 determines a movement speed Vc along the command path over a predetermined time on the basis of the interpolation data. The command ratio calculator 120 also determines an X axis component Vx and a Y axis component Vy of the movement speed. The command ratio calculator 120 then determines a ratio of Vc to Vx as a ratio related to the operation on the X axis, and determines a ratio of Vc to Vy as a ratio related to the operation on the Y axis. Generally, in the case of a command path that moves on an XY plane, the relationship between Vc, Vx, and Vy can be expressed by Equation 1, shown below. Note that in Equation 1, θx is an angle formed by the command path and the X axis, and θy is an angle formed by the command path and the Y axis. More specifically, the ratio of the movement speed Vc to the X axis component Vx of the movement speed and the Y axis component Vy of the movement speed is 1:cos θx:cos θy. Hence, the command ratio calculator 120 may calculate this value as the ratios related to the operations of the respective operating parts. Note that here, an example of movement on an XY plane was described, but similarly in relation to a command path that moves within an XYZ space, for example, the ratios of the movement speed Vc on the command path to the respective axis components Vx, Vy, and Vz of the movement speed can be determined.

$$\{ \begin{matrix}Vx = Vc cos θ x \\ Vy = Vc cos θ y\end{matrix} \qquad [ Equation 1 ]$$

The setting value calculator 130 calculates a predetermined setting value to be used by the controller on the basis of the ratios related to the operations of the respective operating parts, calculated by the command ratio calculator 120, and parameters relating to the respective operating parts, which are stored in the operating parameter storage 210. The setting value calculator 130 stores the calculated predetermined calculation value in the setting value storage 230.

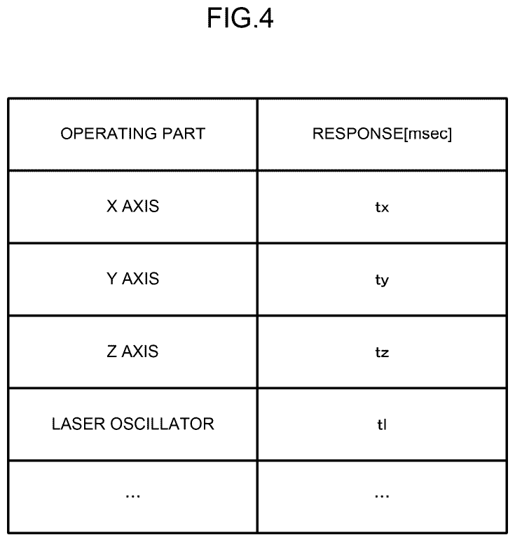

FIG. 4 is a view showing an example of the parameters relating to the respective operating parts, stored in the operating parameter storage 210. As shown in FIG. 4, the parameters relating to the respective operating part axes may be parameters relating to the responses of the respective operating parts, for example. In the example of FIG. 4, the response on the X axis is tx [msec], for example. This means that after a movement command is output in relation to the X axis, a delay of tx [msec] occurs before movement along the X axis actually starts. These parameters may be measured by conducting an experiment using the industrial machine 2, and the measurement results may be stored in advance in the operating parameter storage 210.

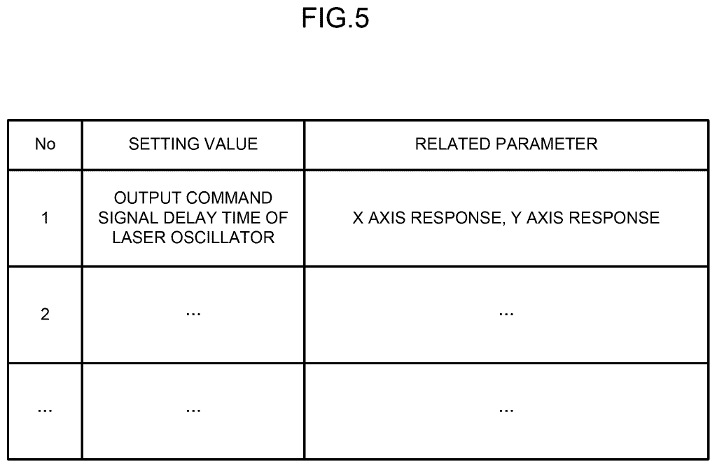

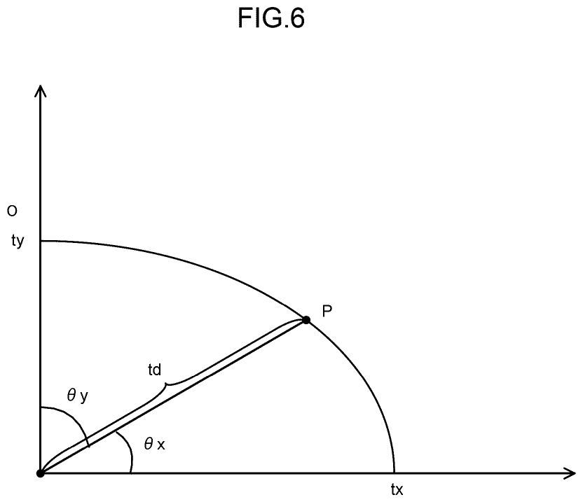

The predetermined setting value calculated by the setting value calculator 130 may be a value that is affected by the predetermined parameters stored in the operating parameter storage 210. When a laser machine is used as the industrial machine 2, a delay time occurring when the output command signal is transmitted to the laser oscillator or other values may be cited as an example. The setting value calculator 130 calculates the predetermined setting value on the basis of a relationship between the predetermined setting value and the parameters relating to the respective operating parts. This relationship may, for example, be set in advance at a fixed value or set in advance in the relationship storage 220. A function for more specifically calculating the setting value may be defined as the relationship. FIG. 5 shows an example of the relationship between the predetermined setting value and the parameters relating to the respective operating parts, which is stored in the relationship storage 220. In the example of FIG. 5, it is shown that the degree to which the output command signal for the laser oscillator is to be delayed is related to the X axis response and the Y axis response. The setting value calculator 130 determines the degree to which the related parameter affects the setting value on the basis of the ratios related to the operations of the respective operating parts, and then calculates the setting value. For example, a command path that moves along the XY plane, as shown in FIG. 3, will be considered. Assuming that the parameters relating to the respective operating parts have been set as shown in FIG. 4, the delay on the X axis and the delay on the Y axis relative to the response of the laser oscillator are, respectively, (tx−tl) [msec] and (ty−tl) [msec]. As described above, the ratio related to the operation on the X axis relative to the speed on the command path is Vx/Vc=cos θx, while the ratio related to the operation on the Y axis is Vy/Vc=cos θy. Taking these ratios as the effects of the respective parameters on the command path, the setting value calculator 130 calculates a delay time td of the output command signal for the laser oscillator as the setting value using Equation 2, shown below, for example. Equation 2, as shown in FIG. 6, is an equation for calculating a distance between the center O of an ellipse in which the delay amount (tx−tl) on the X axis relative to the response of the laser oscillator serves as the semi-major axis (or the semi-minor axis) of the ellipse, and the delay (ty−tl) on the Y axis serves as the semi-minor axis (or the semi-major axis), and an intersection P with a straight line that passes through the center of the ellipse and is inclined by ex degrees from the X axis. Note that the setting value may be calculated by the setting value calculator 130 as desired as long as the calculation is performed on the basis of the ratios related to the operations of the respective operating parts and the related parameters relating to the respective operating parts. For example, another calculation method, such as using the root mean square of a value obtained by multiplying the parameter values pertaining to the respective operating parts, which are related to the predetermined setting value, by the ratio related to the operation, may be employed.

$$td = \sqrt{\frac{1}{{( \frac{cos θ x}{tx - tl} )}^{2} + {( \frac{cos θ y}{ty - tl} )}^{2}}} \qquad [ Equation 2 ]$$

The controller 140 controls the servo motors 50 for driving the industrial machine 2 along the respective axes on the basis of the interpolation data created by the interpolation processor 110. Further, the controller 140 controls the operation of the laser oscillator 60 on the basis of the data for controlling the output signal output to the laser oscillator 60, created by the analyzer 100. The controller 140 refers to the predetermined setting value stored in the setting value storage 230, and uses the predetermined setting value to control the respective operating parts. For example, when the delay time td [msec] is stored in the setting value storage 230 in relation to the output command signal for the laser oscillator, the controller 140 delays the timing at which the output signal is transmitted to the laser oscillator 60 by td [msec].

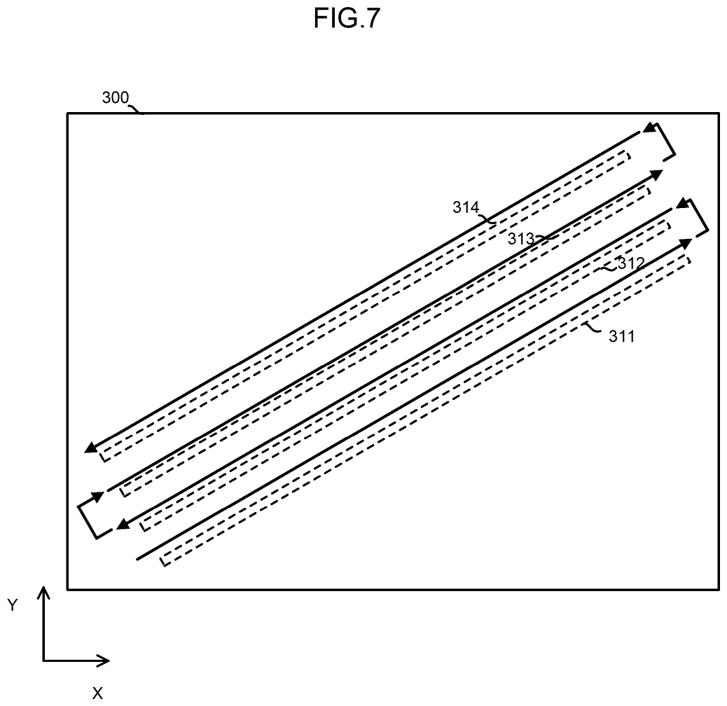

Using FIGS. 7 to 9, an example in which slits are machined in a workpiece by controlling a laser machine using the control device 1 according to this embodiment will be described. FIG. 7 shows machining positions 311 to 314 in which slits are formed in a workpiece 300. In the example of FIG. 7, slits that are inclined relative to the X axis and the Y axis are machined. In a case where machining is performed in this manner, the machining head is successively moved relative to the workpiece 300 in the directions of the arrows, and at the same time, control is performed to switch the laser oscillator 60 ON when the machining head reaches the ranges of the machining positions 311 to 314 and to switch the laser oscillator 60 OFF when the machining head leaves the ranges of the machining positions 311 to 314.

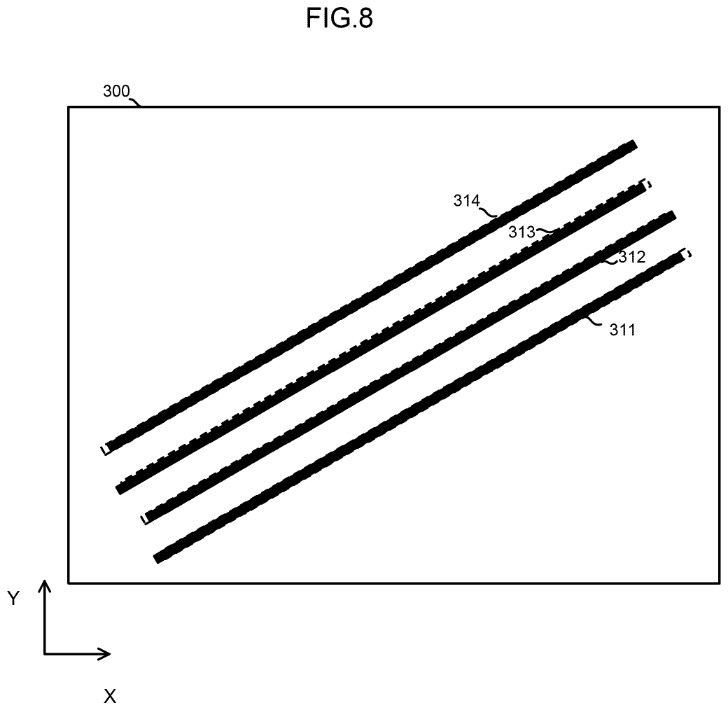

FIG. 8 shows an example of a case in which slits are machined by a laser machine that is controlled by a conventional control device. In FIG. 8, thick black lines indicate positions machined by a laser machine that is controlled by a conventional control device. Likewise with a conventional control device, the delay time of command output to the laser oscillator relative to command output to a predetermined axis can be set in consideration of the delay in the response of the axis relative to the response of the laser oscillator. However, when the delay time relative to the X axis, for example, is set and machining is performed at an incline relative to the X axis, as shown in FIG. 8, the laser oscillator is switched ON ahead of the envisaged machining position. Moreover, when machining is performed by a reciprocating motion, a difference may occur between the ends in a case where machining is performed from the lower left to the upper right and a case where machining is performed from the upper right to the lower left.

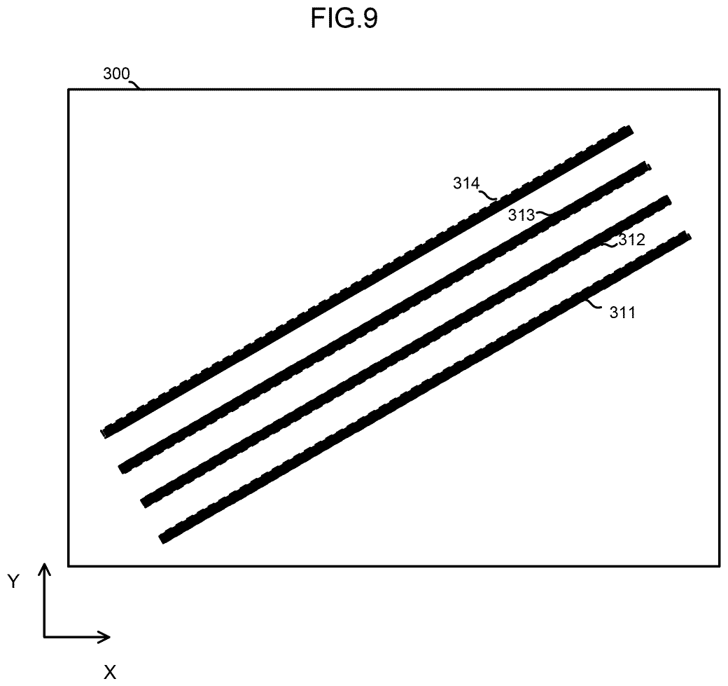

FIG. 9 shows an example of a case in which machining is performed using a laser machine that is controlled by the control device 1 according to this embodiment. In FIG. 9, the thick black lines indicate positions machined by a laser machine that is controlled by the control device 1 according to this embodiment. With the control device 1 according to this embodiment, even when the machined shape is inclined relative to the axis, a more appropriate delay time can be calculated as the setting value on the basis of the ratios relative to the operations of the respective axes. Accordingly, as shown in FIG. 9, the laser oscillator is switched ON in a position closer to the envisaged machining position. Moreover, when machining is performed by a reciprocating motion, the machining can be performed such that the ends are aligned relative to the movement direction.

Note that in the control device 1 according to this embodiment, an example in which the responses of the respective operating parts are used as the parameters relating to the operations of the respective operating parts was described. However, the control device 1 according to this embodiment is not limited thereto, and instead, for example, a signal output adjustment time set for each axis may be used. More specifically, a delay time set for each axis in relation to the laser output command signal output to the laser oscillator 60 may be used as the parameter. Alternatively, another parameter may be used.

Hence, with the control device 1 according to this embodiment, having the configuration described above, it can be expected that more appropriate control, taking into consideration the response of each operating part, will be performed when the response differs among the plurality of driving units. The effect on the setting value of each operating part is calculated automatically in accordance with the operation state thereof. As a result, it is possible to respond to change in the response of each operating part (axis) due to temporal deterioration of the industrial machine 2 or the like simply by modifying the parameter of the relevant operating part. This is particularly effective in applications where, during machining of a workpiece by a laser machine, instead of cutting the workpiece normally by machining in which the workpiece is continuously irradiated with laser, fly cutting is performed to machine a thin plate while switching the laser ON/OFF at high speed, or a raster operation (an operation for sintering the inside of a manufactured object) is performed during additive manufacturing. A particularly large effect can be expected in cases such as that of a galvano scanner, in which slight differences in mechanical properties greatly affect the machining result.

While an embodiment of the present invention was described above, the present invention is not solely limited to the embodiment described above and can be implemented in various aspects by making appropriate modifications.

For example, in the above embodiment, an example in which a laser machine is controlled was described, but the present invention can also be applied to control of a processor such as a water jet machine or the like, for example, in which the response of a water flow output from a cutting head is slower than the response of operations of driving units for moving a table and a machining head. In this case, a time by which output of a water flow output signal is accelerated relative to the movement commands of the axes may be calculated as the predetermined setting value. The present invention can also be used favorably in a machine that performs product inspections in a case where an imaging trigger signal is output in a predetermined position while moving an imaging device and a workpiece relative to each other. In this case, the imaging signal delay time on each axis, including the delay on a transmission path, may be set.

### REFERENCE NUMERALS LIST

1 Control device
2 Industrial machine
11 CPU
12 ROM
13 RAM
14 Nonvolatile memory
15, 17, 18 Interface
16 PLC
19 I/O unit
22 Bus
30 Axis control circuit
35 Oscillator control circuit
40 Servo amplifier
50 Servo motor
60 Laser oscillator
70 Display device
71 Input device
72 External device
100 Analyzer
110 Interpolation processor
120 Command ratio calculator
130 Setting value calculator
140 Controller
200 Machining program
210 Operating parameter storage
220 Relationship storage
230 Setting value storage

1. A control device for controlling a machine having at least two axes on the basis of a machining program, the control device comprising:
a ratio calculator for calculating a ratio related to operations of the axes; and
a setting value calculator for dynamically calculating a setting value of the machine from the ratio calculated by the ratio calculator and a predetermined parameter relating to the axes,
wherein
the setting value of the machine is modified in accordance with the ratio of the operations of the axes.

2. The control device according to claim 1, wherein, in the setting value calculator,
an output adjustment time of an external output signal is modified in accordance with the ratio related to the operations of the axes by calculating a signal output adjustment time of the machine from a signal output adjustment time set for each of the axes.

3. The control device according to claim 1, wherein, in the setting value calculator,
a laser output delay time is modified in accordance with the ratio related to the operations of the axes by calculating a laser output delay time of a laser oscillator from a laser output delay time set for each of the axes.
